(19) United States
(12) Patent Application Publication
(10) Pub. No.: US 2022/0339541 A1
(43) Pub. Date: Oct. 27, 2022

(54) METHODS, APPARATUSES, DEVICES AND STORAGE MEDIA FOR PROCESSING GAME STATES

(71) Applicant: SENSETIME INTERNATIONAL PTE. LTD., Singapore (SG)

(72) Inventors: Xinxin WANG, Singapore (SG); Fei Xie, Singapore (SG)

(21) Appl. No.: 17/364,155

(22) Filed: Jun. 30, 2021

Related U.S. Application Data
(63) Continuation of application No. PCT/IB2021/054779, filed on Jun. 1, 2021.

(30) Foreign Application Priority Data
Apr. 27, 2021 (SG) 10202104316S

(51) Int. Cl. A63F 13/537; G06K 9/00; G06K 9/62; A63F 13/69

(52) U.S. Cl. CPC A63F 13/537; G06K 9/00718; G06K 9/6215; A63F 13/69

(57) ABSTRACT

Methods, apparatuses, devices and storage media for processing game states are provided in the disclosure, the method comprising: in response to a first state switching instruction, switching a game from an idle state to a first state; acquiring first operation information of one or more operations performed on a first marker by a first object participating in the game in the first state; in response to detecting a second marker in a preset area, switching the game to a second state; acquiring second operation information of one or more operations performed on the second marker by a second object participating in the game in the second state; in response to that a game result is generated based on the second operation information, switching the game to a result processing state; performing result processing on the first operation information according to the game result.

### CROSS-REFERENCE TO RELATED APPLICATION

The present application is a continuation of International Application No. PCT/IB2021/054779 filed on Jun. 1, 2021, which claims priority to Singapore Patent Application No. 102021043165, filed on Apr. 27, 2021, all of which are incorporated herein by reference in their entirety.

### TECHNICAL FIELD

The present disclosure relates to the field of computer vision technology, in particular to methods, apparatuses, devices and storage media for processing game states.

### BACKGROUND

At present, during a game, the game process is controlled by a specific personnel based on his/her manual judgment, so as to prevent the game process from abnormal and ensure the game process be smooth. However, this method requires additional human resources and may fail to ensure accuracy of controlling the game process.

### SUMMARY

The present disclosure provides methods, apparatuses, devices and storage media for processing game states.

According to a first aspect of the embodiments of the present disclosure, a method of processing game states is provided, including: in response to a first state switching instruction, switching a game from an idle state to a first state; acquiring first operation information of one or more operations performed on a first marker by a first object participating in the game in the first state; in response to detecting a second marker in a preset area, switching the game to a second state; acquiring second operation information of one or more operations performed on the second marker by a second object participating in the game in the second state; in response to that a game result is generated based on the second operation information, switching the game to a result processing state; performing result processing on the first operation information according to the game result.

In some optional embodiments, the method further includes: in a case that the game is in the second state, in response to determining that the second operation information is abnormal based on a preset operation rule, switching the game to a halt state.

In some optional embodiments, the method further includes: in a case that the game is in the second state or the result processing state, in response to detecting that the first marker in the preset area is changed, switching the game to a halt state.

In some optional embodiments, the method further includes: in a case that the game is in the halt state, switching the game to the first state according to the first state switching instruction; or, switching the game to the second state according to second state switching instruction; or, switching the game to the result processing state according to result state switching instruction.

In some optional embodiments, the preset area includes a first operating area for the first object to perform an operation, acquiring the first operation information of one or more operations performed on the first marker by the first object participating in the game in the first state includes: in a case that the game is in the first state, acquiring, based on a video stream of the preset area, the first operation information of one or more operations performed on the first marker by the first object in the first operating area.

In some optional embodiments, the first operating area includes two or more first operating sub-areas, acquiring the first operation information of one or more operations performed on the first marker by the first object in the first operating area includes: acquiring the first operation information of one or more operations performed on the first marker by the first object in each of the first operating sub-areas.

In some optional embodiments, the preset area includes a second operating area for the second object to perform an operation, acquiring the second operation information of one or more operations performed on the second marker by the second object participating in the game in the second state includes: in a case that the game is in the second state, acquiring, based on a video stream of the preset area, the second operation information of one or more operations performed on the second marker by the second object in the second operating area.

In some optional embodiments, the second operating area includes two or more second operating sub-areas, acquiring the second operation information of one or more operations performed on the second marker by the second object in the second operating area includes: acquiring the second operation information of one or more operations performed on the second marker by the second object in each of the second operating sub-areas.

In some optional embodiments, generating the game result based on the second operation information includes: in a case that the game is in the second state, detecting, based on a video stream of the preset area, second identification information of the second marker in the second operating area; determining the game result based on the second identification information.

In some optional embodiments, the method further includes: in response to switching the game to the first state, acquiring the first operation information from a detection based on an acquired video stream of the preset area; and/or, in response to switching the game to the second state, acquiring the second operation information from a detection based on the acquired video stream of the preset area; the video stream includes respective video streams which are synchronously captured in the preset area from a plurality of viewing angles, the plurality of viewing angles includes at least one side viewing angle and at least one top viewing angle, the at least one side viewing angle includes a left side viewing angle and/or a right side viewing angle.

In some optional embodiments, acquiring the first operation information of one or more operations performed on the first marker by the first object participating in the game in the first state, includes: in response to switching the game to the first state, acquiring the first operation information by performing a detection on a plurality of images included in a video stream of the preset area; performing a detection on any one of the images included in the video stream includes: performing a detection on the image to determine current first identification information of the first marker in the image; determining the first operation information according to a difference between the current first identification information and historical first identification information stored for the game.

In some optional embodiments, acquiring the second operation information of one or more operations performed on the second marker by the second object participating in the game in the second state, includes: in response to switching the game to the second state, acquiring the second operation information by performing a detection on a plurality of images included in a video stream of the preset area; performing a detection on any one of the images included in the video stream includes: performing a detection on the image to determine current second identification information of the second marker in the image; determining the second operation information according to a difference between the current second identification information and historical second identification information stored for the game.

In some optional embodiments, the first marker indicates one or more game coins; the second marker indicates one or more cards; the current second identification information or the historical second identification information includes one or more of the following: card value, suit, information of located area, location information.

According to a second aspect of the embodiments of the present disclosure, an apparatus for processing game states is provided, including: a first state switching module, configured to, in response to a first state switching instruction, switch a game from an idle state to a first state; a first operation information detecting module, configured to acquire first operation information of one or more operations performed on a first marker by a first object participating in the game in the first state; a second state switching module, configured to, in response to detecting a second marker in a preset area, switch the game to a second state; a second operation information detecting module, configured to acquire second operation information of one or more operations performed on the second marker by a second object participating in the game in the second state; a result state switching module, configured to, in response to that a game result is generated based on the second operation information, switch the game to a result processing state; a result processing module, configured to perform result processing on the first operation information according to the game result.

In some optional embodiments, the apparatus further includes: a first halt module, configured to, in a case that the game is in the second state, in response to determining that the second operation information is abnormal based on a preset operation rule, switch the game to a halt state.

In some optional embodiments, the apparatus further includes: a second halt module, configured to, in a case that the game is in the second state or the result processing state, in response to detecting that the first marker in the preset area is changed, switch the game to a halt state.

In some optional embodiments, the first state switching module, configured to, in a case that the game is in the halt state, switch the game to the first state according to the first state switching instruction; or, the second state switching module, configured to, in a case that the game is in the halt state, switch the game to the second state according to second state switching instruction; or, the result state switching module, configured to, in a case that the game is in the halt state, switch the game to the result processing state according to result state switching instruction.

In some optional embodiments, the preset area includes a first operating area for the first object to perform an operation, the first operation information detecting module, configured to, in a case that the game is in the first state, acquire, based on a video stream of the preset area, the first operation information of one or more operations performed on the first marker by the first object in the first operating area.

In some optional embodiments, the first operating area includes two or more first operating sub-areas, the first operation information detecting module, configured to acquire the first operation information of one or more operations performed on the first marker by the first object in each of the first operating sub-areas.

In some optional embodiments, the preset area includes a second operating area for the second object to perform an operation, the second operation information detecting module, configured to, in a case that the game is in the second state, acquire, based on a video stream of the preset area, the second operation information of one or more operations performed on the second marker by the second object in the second operating area.

In some optional embodiments, the second operating area includes two or more second operating sub-areas, the second operation information detecting module, configured to acquire the second operation information of one or more operations performed on the second marker by the second object in each of the second operating sub-areas.

In some optional embodiments, the result state switching module, configured to, in a case that the game is in the second state, detect, based on a video stream of the preset area, second identification information of the second marker in the second operating area; determine the game result based on the second identification information.

In some optional embodiments, the apparatus further includes: a first video stream detecting module, configured to, in response to switching the game to the first state, acquire the first operation information from a detection based on an acquired video stream of the preset area; and/or, a second video stream detecting module, configured to, in response to switching the game to the second state, acquiring the second operation information from a detection based on the acquired video stream of the preset area; the video stream includes respective video streams which are synchronously captured in the preset area from a plurality of viewing angles, the plurality of viewing angles includes at least one side viewing angle and at least one top viewing angle, the at least one side viewing angle includes a left side viewing angle and/or a right side viewing angle.

In some optional embodiments, the first operation information detecting module, configured to, in response to switching the game to the first state, acquire the first operation information by performing a detection on a plurality of images included in a video stream of the preset area; the first operation information detecting module configured to perform a detection on any one of the images included in the video stream by performing a detection on the image to determine current first identification information of the first marker in the image; and, determining the first operation information according to a difference between the current first identification information and historical first identification information stored for the game.

In some optional embodiments, the second operation information detecting module, configured to, in response to switching the game to the second state, acquire the second operation information by performing a detection on a plurality of images included in a video stream of the preset area; the second operation information detecting module configured to perform a detection on any one of the images included in the video stream by performing a detection on the image to determine current second identification information of the second marker in the image; and, determining the second operation information according to a difference between the current second identification information and historical second identification information stored for the game.

In some optional embodiments, the first marker indicates one or more game coins; the second marker indicates one or more cards; the current second identification information or the historical second identification information includes one or more of the following: card value, suit, information of located area, location information.

According to a third aspect of the embodiments of the present disclosure, a computer device is provided, including a memory, a processor and a computer program stored on the memory and executable on the processor, when the computer program is executed by the processor, the method of processing game states according to any one of the first aspect is implemented.

According to a fourth aspect of the embodiments of the present disclosure, a computer readable storage medium storing a computer program is provided, when the computer program is executed by a processor, the method of processing game states according to any one of the first aspect is implemented.

According to a fifth aspect of the embodiments of the present disclosure, a computer program product is provided, including a computer program, when the computer program is executed by a processor, the method of processing game states according to any one of the first aspect is implemented.

In the embodiments of the present disclosure, the game can be switched from the idle state to the first state according to the first state switching instruction, and can be switched to the second state or the result processing state by performing a detection on the preset area. In this way, by dividing the game process into an idle state, a first state, a second state and a result processing state, and switching state of the game based on a detection of the preset area, automatic detecting and controlling of the entire game process can be realized, which is conducive to ensuring the game process be smooth.

It should be understood that the general description and the following detailed description are only exemplary and explanatory, and cannot limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flow chart illustrating a method of processing game states according to an exemplary embodiment;

FIG. 2 is a schematic diagram illustrating a desktop area according to an exemplary embodiment;

FIG. 3 is a schematic diagram illustrating another desktop area according to an exemplary embodiment;

FIG. 4 is a flow chart illustrating a method of determining first operation information according to an exemplary embodiment;

FIG. 5 is a flow chart illustrating a method of determining second operation information according to an exemplary embodiment;

FIG. 6 is a schematic diagram illustrating an apparatus for processing game states according to an exemplary embodiment;

FIG. 7 is a schematic diagram illustrating another apparatus for processing game states according to an exemplary embodiment;

FIG. 8 is a structure schematic diagram illustrating a computer device according to an exemplary embodiment.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. Rather, they are merely examples of apparatuses and methods consistent with some aspects of the present disclosure as detailed in the appended claims.

The terminology used in the present disclosure is for the purpose of describing particular embodiments only and is not intended to limit the present disclosure. The singular forms ‘a’, ‘said’ and ‘the’ used in the present disclosure and the appended claims are also intended to include the majority of forms unless the context clearly indicates other meanings. It should also be understood that the term ‘and/or’ as used herein refers to and includes any or all possible combinations of one or more associated listed items.

It should be understood that although terms like first, second, third, etc. may be used to describe various information in this disclosure, the information should not be limited to these terms. These terms are only used to distinguish the same type of information from each other. For example, without departing from the scope of the present disclosure, first information may also be referred to as second information, and similarly, second information may also be referred to as first information. Depending on the context, the word “if” as used herein may be interpreted as “when” or “upon” or “in response to determining”.

In related technologies, during a game, a specific personnel is expected to detect and control the game process based on his/her manual judgment, so as to ensure the game be smooth. However, this method requires additional human resources for controlling the game process, which not only causes a waste of human resources, but also makes it difficult to ensure accuracy of controlling the game process.

Based on the above, the present disclosure provides a method of processing game states, the entire game process is divided into different states: an idle state, a first state, a second state and a result processing state. In the method of processing game states, according to a detection performed on the preset area, switching of different states during the entire game process, and automatic detection and control for the game process can be realized.

In order to make the method of processing game states provided by the present disclosure clearer, implementation process of solutions provided by the present disclosure will be described in detail below with reference to the accompanying drawings and specific embodiments.

Referring to FIG. 1, which is a flow chart illustrating a method of processing game states according to the embodiments provided by the present disclosure. As shown in FIG. 1, the process includes the following steps.

Step 101, in response to a first state switching instruction, switching a game from an idle state to a first state.

In the embodiment of the present disclosure, the first state switching instruction can be used for instructing that switching the game from current state to the first state. Where the first state switching instruction may be issued in different ways. For example, the first state switching instruction may be issued by a user through performing operations on a client. For example, the first state switching instruction may be issued by a user through a preset specific button.

In this step, in response to the first state switching instruction, state of the game can be switched from the idle state to the first state. Where the idle state indicates a state of being idle prior to starting the game. The first state indicates a state immediately after starting the game, and a first object participating in the game in the first state is allowed to perform one or more operations on a first marker in a preset area.

Step 102, acquiring first operation information of one or more operations performed on a first marker by a first object participating in the game in the first state.

In the embodiment of the present disclosure, the first marker includes props or items of the game in which the first object participates, such as a game coin and the like. After the game is switched from the idle state to the first state in step 101, the first object participating in the game can perform one or more operations on the first marker. In this step, the first operation information of one or more operations performed on the first marker by the first object participating in the game can be acquired. Where the first operation information can be used to indicate relevant information about a process of performing one or more operations on the first marker by the first object in the first state. For example, the number of game coins placed by the first object in the preset area.

It should be noted that the specific manner of acquiring the first operation information of one or more operations performed on the first marker by the first object is not limited in the embodiment of the present disclosure. In a possible implementation, a video stream relevant with the process of performing one or more operations on the first marker by the first object may be acquired in advance, and the first operation information of one or more operations performed on the first marker by the first object can be acquired based on the video stream.

Taking a desktop card game as an example, in step 101, in response to a first state switching instruction triggered by a game dealer, state of the desktop card game can be switched from an idle state to a first state. In a case that the game is in the first state, a game player served as a first object can perform one or more operations on a first marker such as his/her own game coin. For example, the game player can place a game coin in a certain position in desktop area to participate in the desktop card game. In step 102, relevant operation information of one or more operations performed on the game coin by the game player can be acquired based on a pre-acquired video stream of the desktop area. For example, it can be acquired that 10 game coins are placed in the desktop area based on the video stream.

Step 103, in response to detecting a second marker in a preset area, switching the game to a second state.

In the embodiment of the present disclosure, the preset area indicates an area provided for performing one or more operations relevant with the game process. For example, during a process of a desktop card game, it is expected to place cards or game props in desktop area for gaming, and the desktop area can be taken as a preset area. The second marker includes items or props used for determining a game result during the game process. For example, a card used to determine a game result in a desktop card game can be taken as the second marker in the embodiment of the present disclosure. The second state indicates a state after starting the game, and a second object participating in the game in the second state is allowed to perform one or more operations on the second marker in the preset area.

In this step, a detection can be performed on the preset area to determine whether a second marker exists in the preset area. Where the specific manner of performing a detection on the preset area to determine whether a second marker exists in the preset area is not limited in the embodiment of the present disclosure. In a possible implementation, a video stream of the preset area can be acquired in advance, and whether a second marker exists in the preset area can be determined based on a detection of the video stream. For example, in a desktop card game, a video stream of desktop area can be acquired in advance, and whether a second marker such as a card exists in the desktop area can be determined by performing a detection on the video stream. Further, in a case of determining that a second marker exists in the preset area, the game can be switched from the first state to the second state in this step.

Step 104, acquiring second operation information of one or more operations performed on the second marker by a second object participating in the game in the second state.

After the game is switched to the second state in step 103, the second object participating in the game can perform one or more operations on the second marker. For example, when a desktop card game is in the second state, a game dealer served as the second object may deal cards which are taken as the second marker to determine a game result according to the dealt cards.

In this step, the second operation information of one or more operations performed on the second marker by the second object participating in the game can be acquired. Where the second operation information can be used to indicate relevant information about a process of performing one or more operations on the second marker by the second object in the second state. For example, the number of cards dealt by a game dealer which is served as the second object in the preset area. Exemplarily, the second operation information may include: a second object places second marker 1 in first sub-area of a desktop area; the second object places second marker 2 in second sub-area of the desktop area.

Taking an operation of dealing cards performed by a game dealer as an example, the second operation information acquired in this step may include: the game dealer deals the first card to a first card dealing area in a desktop area, the second card to a second card dealing area in the desktop area, the third card to the first card dealing area in the desktop area and the fourth card to the second card dealing area in the desktop area.

It should be noted that the specific manner of acquiring the second operation information of one or more operations performed on the second marker by the second object is not limited in the embodiment of the present disclosure. In a possible implementation, a video stream relevant with the process of performing one or more operations on the second marker by the second object may be acquired in advance, and the second operation information of one or more operations performed on the second marker by the second object can be acquired based on the video stream.

Still taking the desktop card game as an example, in step 103, whether a card that is taken as the second marker exists in a desktop area that is taken as the preset area can be determined by detecting the desktop area. If there is a card in the desktop area, it means that a game dealer served as the second object has already dealt cards. At this time, state of the desktop card game should be switched to the second state. In a case that the game is in the second state, the game dealer served as the second object is expected to deal cards to determine a game result of the desktop card game according to the dealt cards. In step 104, relevant operation information of one or more operations performed on the cards by the game dealer can be acquired based on a pre-acquired video stream of the desktop area. For example, it can be acquired based on the video stream that the number of cards dealt by the game dealer in the desktop area.

Step 105, in response to that a game result is generated based on the second operation information, switching the game to a result processing state.

When the second object performs an operation on the second marker in the second state, corresponding second operation information can be acquired. For example, when a game dealer deals cards in the second state, corresponding operation information of dealing cards can be acquired. For example, a game dealer has dealt a total of 4 cards in a desktop area.

Whether a game result may be acquired can be determined according to the acquired second operation information in this step. For example, whether a game result may be acquired can be determined based on cards dealt by the game dealer in the desktop area. If a game result may be generated based on the second operation information, the game can be switched to the result processing state in this step.

There may be a variety of specific ways for generating the game result according to the second operation information, which are not limited by the present disclosure. Taking a desktop card game as an example, a game result of the desktop card game can be determined according to points or suits of the cards in a desktop area. In addition, the game result can be displayed in various forms, which can be set according to actual conditions. Exemplarily, the game result may be displayed as a first object that wins the game or a first object that loses the game; or, the game result may also be displayed as a first marker for winning the game or a first marker for losing the game.

Step 106, performing result processing on the first operation information according to the game result.

When the game result is determined, the game can be switched from the second state to the result processing state in the step 105. In a case that the game is in the result processing state, result processing can be performed on the first operation information according to the game result.

Still taking the desktop card game as an example, when the game results of different first objects participating in the game are determined according to points of the cards in the desktop area, the game may be switched to the result processing state in step 105. When the game is in the result processing state, according to a preset game rule, one or more first markers may be given to a first object who wins the game as a reward; or, one or more first markers may be taken away from a first object who loses the game. It can be understood that the above ways of processing game results are only exemplary descriptions, and actual processing process can be flexibly processed according to specific game rules.

In the embodiment of the present disclosure, the game can be switched from the idle state to the first state according to the first state switching instruction, and the game can be switched to the second state or the result processing state by performing a detection on the preset area. In this way, by dividing the game process into an idle state, a first state, a second state, and a result processing state, and switching state of the game according to a detection performed on the preset area, and running corresponding game detection logic in predetermined state, such that automatic detection and control of the game process can be realized and efficiency of game detection and controlling can be improved.

In some optional embodiments, in a case that the game is in the second state, in response to determining that the second operation information is abnormal based on a preset operation rule, switching the game to a halt state.

In the process of performing an operation on the second marker in the second state, the second object is usually expected to comply with certain operation rules. Where the operation rules are used to regulate operation process of one or more operations performed on the second marker by the second object, so as to ensure that the game can be played in accordance with rules. For example, taking the desktop card game as an example, a game dealer served as the second object is expected to deal cards to specified position according to a certain dealing order.

In the above embodiments, in a case that the game is in the second state, whether the second operation information of one or more operations performed on the second marker by the second object is abnormal can be determined based on a preset operation rule. Taking the desktop card game as an example, dealing rules for the game dealer to deal cards can be set in advance. When the game is in the second state, for the game dealer dealing cards, whether the cards dealing is abnormal can be determined based on the preset dealing rules in the above embodiments.

The specific implementation of determining that whether the second operation information is abnormal based on the preset operation rule is not limited in the embodiment of the present disclosure. In a possible implementation, algorithms such as neural network can be used to identify the second operation information of one or more operations performed on the second marker by the second object in the preset area, and the second operation information can be compared with business logic set by a business logic layer to determine whether the second operation information is abnormal. In a case that the second operation information is abnormal, the game can be switched to a halt state. The game is in the halt state indicates that the game cannot be performed normally, and abnormal behaviors generated during the game should be dealt with.

The process of switching the game from the second state to the halt state will be illustrated by taking the desktop card game as an example. Area A1 and area A2 can be pre-divided from a desktop area, and dealing order of a game dealer in game rules can be preset as: the first card is dealt to the area A1; the second card is dealt to the area A2; the third card is dealt to the area A1; and the fourth card is dealt to the area A2. In the embodiment of the present disclosure, based on acquired operation information of dealing operations performed on cards by the game dealer in the desktop area, and the dealing order of the game dealer in preset game rules, whether the operation information is abnormal can be determined. For example, if the game dealer deals the third card to area A2, then the operation information is abnormal, and the game can be switched to the halt state at this time.

In the above embodiments, in a case that operation of the second object is abnormal, the game can be switched to the halt state in time. In this way, abnormal operation of the second object can be found in time, and the game can be switched to the halt state to suspend game detection logic and reduce possibility of occurring errors in result of game detection.

In some optional embodiments, in a case that the game is in the second state or the result processing state, in response to detecting that the first marker in the preset area is changed, switching the game to a halt state.

In a case that the game is in the first state, a first object participating in the game can perform one or more operations on a first marker in a preset area. For example, in the first state, a game player can place his/her own game coins in a prescribed position of a desktop area. A game dealer is expected to perform a card dealing operation when the game coins are placed by the game player in the prescribed position. Once the game dealer starts to perform the card dealing operation, it means that the game has been switched to the second state, the game coins placed by the game player are usually not allowed to be changed after that. For example, the game player cannot continue to increase the game coins or change attribution position of the game coins when the game dealer starts to deal cards.

In the above embodiments, in other states after the end of the first state, that is, in the second state or in the result processing state, the first marker in the preset area can be detected to determine whether the first marker in the preset area is changed. If the first marker in the preset area is changed, for example, the number or position of the first marker is changed, the game can be switched to the halt state. Where the change of the first marker may include, but is not limited to, change in the number and position of the first marker.

Taking the desktop card game as an example, in the process of the game dealer dealing cards (the game is in the second state), a game player transfers his/her game coins from area B1 to area B2 in the desktop area. Then in the above embodiments, change of the game coins in the desktop area can be detected, and the game can be switched to the halt state.

Taking the desktop card game as an example, when a game result is determined based on the dealt cards in the desktop area (the game is in the result processing state), a game player transfers his/her game coins from the area B1 to the area B2 in the desktop area based on the game result. Then in the above embodiments, change of the game coins in the desktop area can be detected, and the game can be switched to the halt state.

In the above embodiments, in a case of detecting that the game coins in the desktop area are changed, the game can be switched to the halt state. In this way, abnormal behavior for change of the first marker in the preset area can be effectively detected, and state of the game can be changed to deal with the abnormal behavior, which improves fairness and standardization of the game process, and enhances game experience of game participants.

In the above embodiments, the game is switched to the halt state under different abnormal situations to deal with abnormal behavior that occurs. For example, in a case that the game is in the second state, if second operation information is determined as abnormal based on a preset operation rule, the game can be switched to the halt state. For example, in a case that the game is in the second state or the result processing state, if detecting that the first marker in the preset area is changed, the game can be switched to the halt state.

When the game is switched to the halt state, the game could not proceed according to normal flow, and abnormal situations generated during the game process are expected to be dealt with to meet requirements of continuing the game. For example, abnormal second operation information can be processed according to the preset operation rule, such that the second operation information conforms to the preset operation rule. For example, the changed first marker can be restored to its original state to eliminate abnormity caused by the change of the first marker.

In some optional embodiments, in a case that the game is in the halt state, switching the game to the first state according to a first state switching instruction. Where the first state switching instruction may be issued through different forms, which is not limited in the embodiment of the present disclosure. For example, the first state switching instruction may be issued by a user based on a client.

Taking the desktop card game as an example, in a case that the game is in the second state, a game player increases the number of game coins in the desktop area again (violating the game rule) during a game dealer dealing cards. At this time, it can be detected that the first marker is changed, and the game can be switched to the halt state. Further, in a case that the game is in the halt state, relevant personnel may request the game player to restore the game coins to its original state. In the embodiment of the present disclosure, when the game coins are restored to the original state, the game can be switched to the first state again based on a first state switching instruction triggered by a staff, so as to continue with normal flow of the game.

In some optional embodiments, in a case that the game is in the halt state, switching the game to the second state according to second state switching instruction; or, in a case that the game is in the halt state, switching the game to the result processing state according to result state switching instruction. Similar to the process of switching the game to the first state according to the first state switching instruction, in the embodiment of the present disclosure, the game can be restored from the halt state to original second state according to the second state switching instruction; or, the game can be restored from the halt state to original result processing state according to the result state switching instruction.

In the above embodiments, in a case that the game is in the halt state, when abnormal behavior generated during the game process is processed, the game can be restored to normal state to continue the game, if it is determined that there are no abnormities or abnormities do not affect the game.

In some optional embodiments, the preset area includes a first operating area for the first object to perform an operation, acquiring the first operation information of one or more operations performed on the first marker by the first object participating in the game in the first state includes: in a case that the game is in the first state, acquiring, based on a video stream of the preset area, the first operation information of one or more operations performed on the first marker by the first object in the first operating area.

In the above embodiments, a specific area for the first object to perform an operation on the first marker in the preset area may be preset as the first operating area. For example, in a case that a desktop area is taken as the preset area in the desktop card game, a specific area for game players to place game coins can be divided from the desktop area, and taken as the first operating area.

In a case that the game is in the first state, the first object can perform one or more operations on the first marker in the first operating area. In the above embodiments, the first operation information of one or more operations performed on the first marker by the first object in the first operating area can be acquired from a detection based on the video stream of the preset area.

The video stream of the preset area can be obtained through a variety of different forms, which is not limited in the embodiment of the present disclosure. In a possible implementation, the video stream of the preset area can be obtained through a preset video capture device. For example, a video capture device can be installed above a desktop area used in a desktop card game to obtain a video stream of the desktop area.

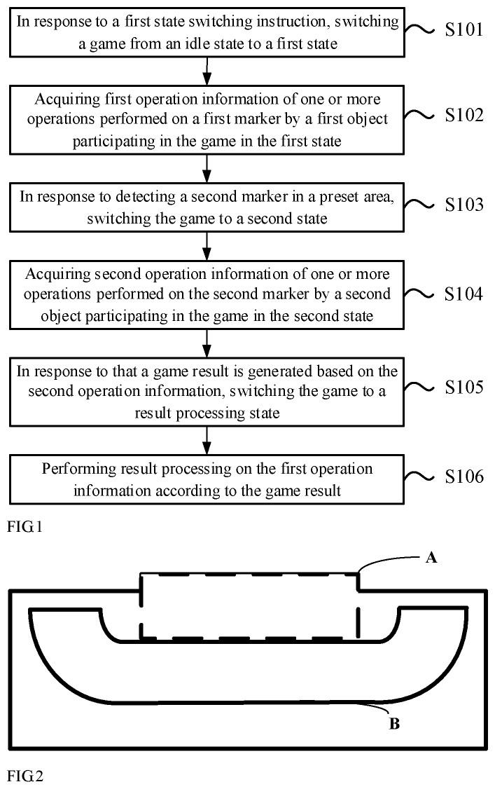

Referring to FIG. 2, which is a schematic diagram illustrating an image from the video stream of the desktop area, where the desktop area is taken as the preset area, and the area B used for performing one or more operations on game coins by game players in the preset area can be taken as the first operating area of the desktop card game. In the desktop card game, a game player served as the first object can only place one or more game coins in the area B according to a game rule to participate in the desktop card game. In a case that the game is in the first state, operation information of one or more operations performed on the game coins by the game player in the area B can be acquired based on the video stream of the desktop area, and can be taken as the first operation information in the above embodiments.

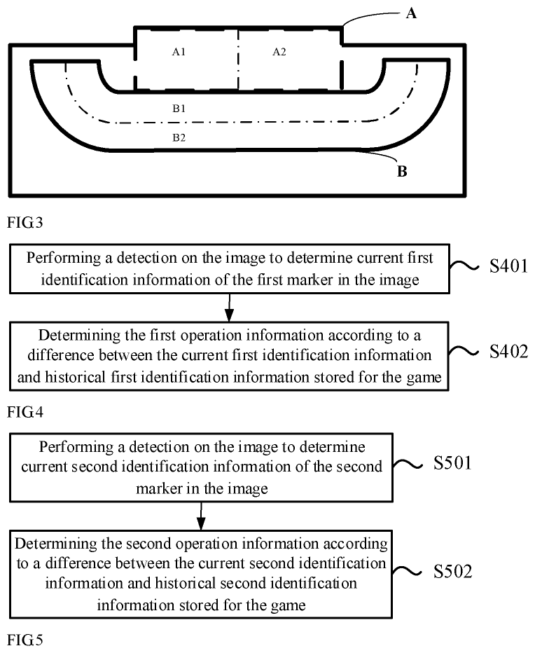

In some optional embodiments, the first operating area may be further divided into two or more first operating sub-areas. Where different first operating sub-areas can be used for different game functions or used by different game roles such as banker, player and the like. For example, when an object participating in the game places some first markers in a first operating sub-area, it indicates that the object participating in the game selects to take the game role corresponding to the first operating sub-area in the game. Taking FIG. 3 as an example, the area B which is taken as the first operating area can be divided into two first operating sub-areas, a sub-area B1 and a sub-area B2, which correspond to two game roles against each other.

In a case that the first operating area includes two or more first operating sub-areas, the first operation information of one or more operations performed on the first marker by the first object in each of the first operating sub-areas can be acquired. Taking FIG. 3 as an example, where the area B is taken as the first operating area, and the sub-area B1 and the sub-area B2 included in the area B are taken as two first operating sub-areas. In the desktop card game, a game player can choose to place his/her own game coins in the sub-area B1 or the sub-area B2 to participate in the desktop card game.

In the above embodiments, the area used for the first object to perform one or more operations in the preset area can be taken as the first operating area, and the first operating area can be divided into two or more first operating sub-areas. Based on a detection on a video stream of the preset area, operation information of one or more operations performed on the first marker by the first object in the two or more first operating sub-areas can be determined as the first operation information. In this embodiment, by dividing the preset area into different sub-areas, operation information of one or more operations performed on the first marker by the first object in the preset area can be acquired more efficiently and accurately.

In some optional embodiments, the preset area includes a second operating area for the second object to perform an operation, acquiring the second operation information of one or more operations performed on the second marker by the second object participating in the game in the second state includes: in a case that the game is in the second state, acquiring, based on a video stream of the preset area, the second operation information of one or more operations performed on the second marker by the second object in the second operating area.

In the above embodiments, a specific area for the second object to perform an operation on the second marker may be preset in the preset area as the second operating area. For example, in a case that a desktop area is taken as the preset area in the desktop card game, a specific area for a game dealer to perform an operation of dealing cards can be divided from the desktop area, and taken as the second operating area.

In a case that the game is in the second state, the second object can perform one or more operations on the second marker in the second operating area. In the above embodiments, the second operation information of one or more operations performed on the second marker by the second object in the second operating area can be acquired from a detection based on the video stream of the preset area.

Referring to FIG. 2, which is a schematic diagram illustrating an image from a video stream of the desktop area, where the desktop area is taken as the preset area, and the area A used for performing dealing operations on cards by a game dealer in the preset area can be taken as the second operating area of the desktop card game. In a case that the game is in the second state, operation information of one or more dealing operations performed on the cards by the game dealer in the area A can be acquired based on the video stream of the desktop area, and can be taken as the second operation information in the above embodiments.

In some optional embodiments, the second operating area may be further divided into two or more second operating sub-areas. Where different second operating sub-areas can be used for different game functions or used by different game roles. A game result can be determined based on the second marker(s) in the second operating sub-areas as well as respective game roles corresponding to the second operating sub-areas. There is a one-to-one association between the second operating sub-areas and the above first operating sub-areas. When one of the second operating sub-areas is determined as a target second sub-area corresponding to a winner of the game roles according to the second marker(s) in respective second operating sub-areas, the first operating sub-area associated with the target second sub-area can determined as corresponding to the winner. Taking FIG. 3 as an example, the area A which is taken as the second operating area can be divided into two second operating sub-areas: area A1 and area A2.

In a case that the second operating area includes two or more second operating sub-areas, the second operation information of one or more operations performed on the second marker by the second object in each of the second operating sub-areas can be acquired. Taking FIG. 3 as an example, where the area A is taken as the second operating area, and the sub-area A1 and the sub-area A2 included in the area A are taken as two second operating sub-areas.

In the desktop card game, a game dealer can deal cards to the sub-area A1 or the sub-area A2 according to a game rule, so as to determine game result of the desktop card game according to the cards dealt to different sub-areas. In the above embodiments, cards respectively dealt by the game dealer in the sub-area A1 and the sub-area A2 can be detected to acquire corresponding second operation information. Exemplarily, the acquired second operation information can be as follows: the second object sequentially places second marker 1 in the sub-area A1 and second marker 2 in the sub-area A2.

In the above embodiments, the area used for the second object to perform operations in the preset area can be taken as the second operating area, and the second operating area can be divided into two or more second operating sub-areas. Based on a detection on a video stream of the preset area, operation information of one or more operations performed on the second marker by the second object in the two or more second operating sub-areas can be determined as the second operation information. In this embodiment, by dividing the preset area into different sub-areas, operation information of one or more operations performed on the second marker by the second object in the preset area can be acquired more efficiently and accurately.

In some optional embodiments, the specific process of generating a game result based on the second operation information in step 105 may include: in a case that the game is in the second state, detecting, based on a video stream of the preset area, second identification information of the second marker in the second operating area; determining the game result based on the second identification information.

In a case that the game is in the second state, the second object can perform one or more operations on the second marker in the second operating area. For example, in a case that the game is in the second state, a game dealer served as the second object can deal cards in the second operating area of the desktop area.

In the above embodiments, the second identification information of the second marker on which operations are performed by the second object in the second operating area can be detected based on the video stream of the preset area. Where the second identification information can be used to indicate different second markers, and the game result can be determined based on second identification information of different second markers. For example, in a case that a card is taken as the second marker, card value, suit and other information carried on the card can be taken as the second identification information in the embodiment of the present disclosure.

Taking the desktop card game as an example, in the above embodiments, card value, suit, and other information of the card dealt by the game dealer in the second operating area can be determined based on a detection on the video stream of the desktop area. Thus, a game result of the desktop card game can be further determined based on card value, suit and other information of the card.

In some optional embodiments, in a case that the second operating area includes two or more second operating sub-areas, second identification information of the second marker in each of the second operating sub-areas can be detected based on the video stream of the preset area; and the game result can be determined according to the second identification information for each of the second operating sub-areas.

Taking FIG. 3 as an example, the area A is taken as the second operating area, and the sub-area A1 and the sub-area A2 included in the area A are taken as two second operating sub-areas. In the desktop card game, a game dealer can deal cards to the sub-area A1 or the sub-area A2 according to a game rule. In the above embodiments, based on a detection on the video stream of the preset area, information such as card value, suit, etc. of the cards dealt by the game dealer to the sub-area A1 and the sub-area A2 can be determined, such that a game result of the desktop card game can be determined according to related information of cards in the sub-area A1 and the sub-area A2.

In the above embodiments, the area used for the second object to perform an operation in the preset area is taken as the second operating area, and the second operating area may be further divided into two or more second operating sub-areas. Based on a detection on the video stream of the preset area, the second identification information of the second marker in the two or more second operating sub-areas can be determined, and the game result can be determined according to the second identification information of different second operating sub-areas. In the embodiment, by dividing the preset area into different areas, it can be more efficient and accurate for detecting the second identification information in the preset area, and determining the game result.

In a case that the game is in first state, first operation information can be acquired from a detection based on a video stream of the preset area; in a case that the game is in second state, second operation information can be acquired from a detection based on the video stream of the preset area. In a possible implementation, the video stream of the preset area may be a video stream captured from the same viewing angle. For example, the video stream of the preset area may be captured from a top viewing angle directly above the preset area, such that the first operation information or the second operation information can be determined according to a detection on the captured video stream.

In some optional embodiments, in response to switching the game to the first state, the first operation information can be acquired from a detection based on an acquired video stream of the preset area; and/or, in response to switching the game to the second state, the second operation information can be acquired from a detection based on the acquired video stream of the preset area; where, the video stream includes video streams which are synchronously captured in the preset area from a plurality of viewing angles.

In the above embodiments, the video stream of the preset area can be synchronously captured from a plurality of viewing angles. For example, a video capture device can be set directly above the preset area, to obtain a video stream of the preset area from a top viewing angle. Referring to FIG. 2, which illustrates an image comprised in a video stream captured by a video capture device set directly above the desktop area. Optionally, a video capture device can also be set on the upper side of the preset area, to capture a video stream of the preset area from the upper side in a bird's eye view synchronously. For example, a camera can be set on the diagonally upside of desktop area to capture a video stream of the preset area synchronously.

In the above embodiments, the video stream can be synchronously captured from a plurality of viewing angles, the plurality of viewing angles includes at least one side viewing angle and at least one top viewing angle, the at least one side viewing angle includes a left side viewing angle and/or a right side viewing angle, such that a detection can be performed on the preset area according to the captured video stream. In this way, a more comprehensive video stream of the preset area can be obtained, such that a more accurate detection of the preset area can be realized. Further, by capturing video streams from a plurality of viewing angles in a case that a single viewing angle may lead to a shade, the first operation information and the second operation information can be determined more accurately, and accuracy of the game detection result can be improved.

In some optional embodiments, when acquiring the first operation information in step 102, in response to switching the game to the first state, the first operation information can be determined by performing a detection on a plurality of images comprised in a video stream of the preset area.

Since the video stream includes a plurality of images, the process of acquiring the first operation information from a detection based on the video stream, is actually a process of separately performing a detection on each of the plurality of images comprised in the video stream and determining the first operation information. As shown in FIG. 4, performing a detection on any one of the images comprised in the video stream includes the following steps.

Step 401, performing a detection on the image to determine current first identification information of the first marker in the image.

The current first identification information indicates first identification information corresponding to the first marker, which is detected from the image being processed currently. For example, a detection can be performed on current image, to determine the number of game coins involved in the image, and the determined number can be taken as the current first identification information corresponding to the first marker.

Step 402, determining the first operation information according to a difference between the current first identification information and historical first identification information stored for the game.

During a complete round of game, when acquiring first operation information from a detection based on a video stream of the preset area, a plurality of images comprised in the video stream are to be scanned one by one. In the embodiment of the present disclosure, every time first identification information for one image comprised in the video stream is detected, the first identification information for the image can be stored as historical first identification information.

In step 401, first identification information for the image on which a detection is performing currently can be acquired as current first identification information. In this step, the current first identification information detected from the image on which a detection is currently performing can be compared with the historical first identification information previously detected and stored for the game, and the first operation information can be determined according to the difference between the current first identification information and the historical first identification information.

Exemplarily, taking that the video stream of the preset area includes a first image and a second image as an example for description. It is understandable that the video stream does not only include the first and second image, and the two images used herein are for illustration in the embodiment of the present disclosure.

In step 401, a detection can be performed on the first image comprised in the video stream to acquire the current first identification information corresponding to the first marker involved in the first image. Since in step 401, it is the first image comprised in the video stream that a detection is performed on, that is, before the first image, detection on the other images comprised in the video stream haven't been performed, so historical first identification information is not pre-stored yet. Or, it can be understood that the historical first identification information is empty. In step 402, according to a difference between the current first identification information acquired from a detection on the first image and the historical first identification information (empty), the image being processed currently can be determined as the first image comprised in the video stream.

When the first identification information for the first image comprised in the video stream is acquired, the first identification information can be stored to obtain historical first identification information. In step 401, a detection can be performed on the second image comprised in the video stream to acquire the current first identification information corresponding to the first marker in the second image. In step 402, the first operation information can be determined according to a difference between the current first identification information acquired from the second image and the historical first identification information acquired from the first image.

In the above embodiments, detection on a plurality of images comprised in the video stream may be performed separately, and first operation information may be determined based on difference between the first identification information detected currently and the stored first identification information. For example, first identification information acquired from a detection performed on a first image is: there are no game coins in sub-area B1, and the first identification information is stored as historical first identification information; first identification information acquired from a detection performed on a second image is: there are 10 game coins in the sub-area B1, and the first identification information is taken as current first identification information. Thus, according to a difference between the historical first identification information (there are no game coins in the sub-area B1) and the current first identification information (there are 10 game coins in the sub-area B1), first operation information can be determined as: a game player has added 10 game coins in the sub-area B1.

In some optional embodiments, when acquiring the second operation information in step 104, in response to switching the game to the second state, the second operation information can be determined by performing a detection on a plurality of images comprised in a video stream of the preset area.

Since the video stream includes a plurality of images, the process of acquiring the second operation information from a detection based on the video stream, is actually a process of performing a detection on the plurality of images comprised in the video stream to acquire the second operation information. As shown in FIG. 5, performing a detection on any one of the images comprised in the video stream includes the following steps.

Step 501, performing a detection on the image to determine current second identification information of the second marker in the image.

The current second identification information indicates second identification information corresponding to the second marker, which is detected from the image being processed currently. For example, a detection can be performed on current image, to determine card value and suit of cards involved in the image, and the determined card value and suit can be taken as the current second identification information corresponding to the second marker.

Step 502, determining the second operation information according to a difference between the current second identification information and historical second identification information stored for the game.

During a complete round of game, when acquiring second operation information from a detection based on a video stream of the preset area, a plurality of images comprised in the video stream are to be scanned one by one. In the embodiment of the present disclosure, every time second identification information for one image comprised in the video stream is detected, the second identification information for the image can be stored as historical second identification information.

In step 501, second identification information for the image on which a detection is performing currently can be acquired as current second identification information. In this step, the current second identification information can be compared with the historical second identification information previously detected and stored for the game, and the second operation information can be determined according to the difference between the current second identification information and the historical second identification information.

Exemplarily, taking that the video stream of the preset area includes a first image and a second image as an example for description. In step 501, a detection can be performed on the first image comprised in the video stream to acquire the current second identification information corresponding to the second marker involved in the first image. Since it is the first image comprised in the video stream that a detection is performed on, historical second identification information is not pre-stored yet, that is, the historical second identification information is empty. In step 502, according to a difference between the current second identification information acquired from a detection on the first image and the historical second identification information (empty), the image being processed currently can be determined as the first image comprised in the video stream.

When the second identification information for the first image comprised in the video stream is acquired, the second identification information can be stored to obtain historical second identification information. In step 501, a detection can be performed on the second image comprised in the video stream to acquire the current second identification information corresponding to the second marker in the second image. In step 502, the second operation information can be determined according to a difference between the current second identification information acquired from the second image and the historical second identification information acquired from the first image.

In the above embodiments, detection on a plurality of images comprised in the video stream may be performed separately, and the second operation information may be determined based on a difference between the second identification information detected currently and the stored second identification information.

For example, second identification information acquired from a detection based on a first image is: there are no cards in sub-area A1, and the second identification information is stored as historical second identification information; second identification information acquired from a detection based on a second image is: there is one card: 5 of hearts in the sub-area A1, and the second identification information is taken as current second identification information. Thus, according to a difference between the historical second identification information (there are no cards in sub-area A1) and the current second identification information (there is one card: 5 of hearts in the sub-area A1), second operation information can be determined as: a game dealer places one card: 5 of hearts in the sub-area A1.

In some optional embodiments, the first marker indicates one or more game coins; the second marker indicates one or more cards; the current second identification information or the historical second identification information includes one or more of the following: card value, suit, information of located area, location information and confidence.

The information of located area is used to characterize specific area to which the second marker belongs in the preset area. For example, in a case that a card is located in sub-area A1, the information of located area may include: the sub-area A1. The location information is used to characterize specific location of the second marker in the preset area. Exemplarily, a coordinate system may be established in a preset area in advance, and position coordinates of the second marker in the coordinate system may be used as the position information. It is understandable that the location information may also include more specific manners, and this embodiment is only an example for description. The confidence is used to characterize the credibility for the currently detected second marker. Exemplarily, in a case of detecting that current card is “3 of hearts”, detecting system may determine that confidence for the card “3 of hearts” is 0.99.

In the course of the game, situations such as flops, occlusions, and changes of card value occur frequently, and information of all cards may not be acquired through a certain image comprised in a video stream.

In a possible implementation, second identification information of the second marker in the process for a complete round of game can be cached. Optionally, during the caching process, the second identification information in cache may be updated timely according to a second marker newly appeared in the video stream. For example, when a card is newly added to the preset area, information of the card can be added to the cache. Optionally, in a case that the second marker in the preset area is changed, second identification information is correspondingly updated in the cache.

Second identification information of the second marker in the process for a complete round of game can be cached. Thus, sequence of operations performed on the second marker can be quickly identified from the image or the video stream by comparing the second identification information with the information in the cache, and in a case of expecting to review data for game process, the second identification information of the second marker in the game process can be checked more conveniently. In this way, it is more convenient to re-check the game process, and increase efficiency of checking game, and improve standardization and fairness of the game, which are conduce to improve game experience.

In some optional embodiments, the method further includes: in the process of one round of game, caching data generated in different states of the game respectively into different buffer areas; where the different buffer areas are independent of each other. The data generated in different states of the game may include any information detected when the game is in respective states. For example, the number and location of detected game coins in the desktop area. For another example, card value, suit, etc. of detected card in the desktop area. Specific content of data generated in different states of the game is not limited in this embodiment.

For example, data generated when the game is in the first state may be cached into a first cache area, data generated when the game is in the second state may be cached into a second cache area, and data generated when the game is in the result processing state may be cached into a third cache area. The first cache area, the second cache area and the third cache area cached independently of each other.

In the above embodiments, in the process of caching data generated during a complete round of game, data may be cached independently according to different states of the game. Thus, it can be more convenient to store, update, or search data for different states. In this way, independent caching can be realized for different states of the game, which may facilitate update of game data, detection and switching of real-time states.

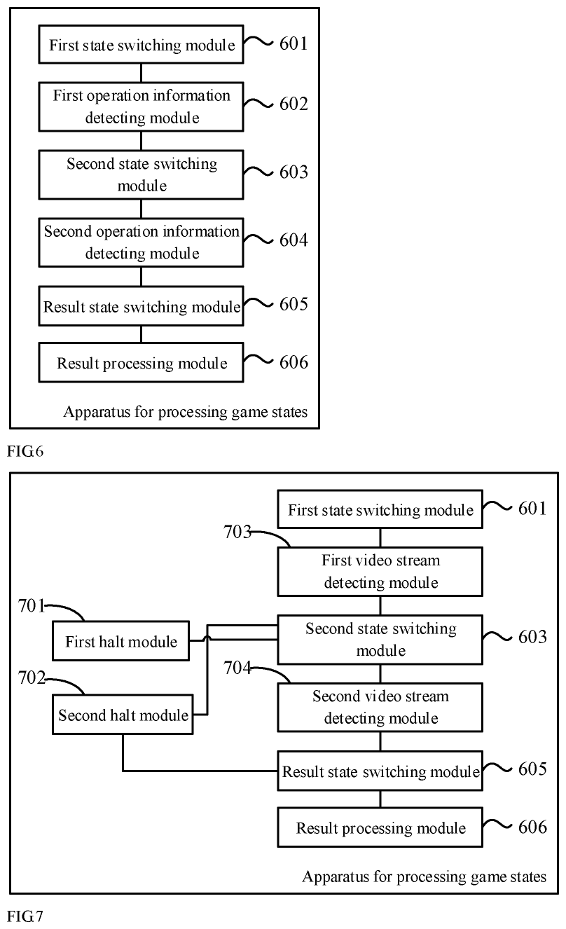

As shown in FIG. 6, the present disclosure provides an apparatus for processing game states, which can execute the method of processing game states provided by any embodiment of the present disclosure. The apparatus may include: a first state switching module 601, a first operation information detecting module 602, a second state switching module 603, a second operation information detecting module 604, a result state switching module 605 and a result processing module 606.

The first state switching module 601, configured to, in response to a first state switching instruction, switch a game from an idle state to a first state; the first operation information detecting module 602, configured to acquire first operation information of one or more operations performed on a first marker by a first object participating in the game in the first state; the second state switching module 603, configured to, in response to detecting a second marker in a preset area, switch the game to a second state; the second operation information detecting module 604, configured to acquire second operation information of one or more operations performed on the second marker by a second object participating in the game in the second state; the result state switching module 605, configured to, in response to that a game result is generated based on the second operation information, switch the game to a result processing state; and the result processing module 606, configured to perform result processing on the first operation information according to the game result.

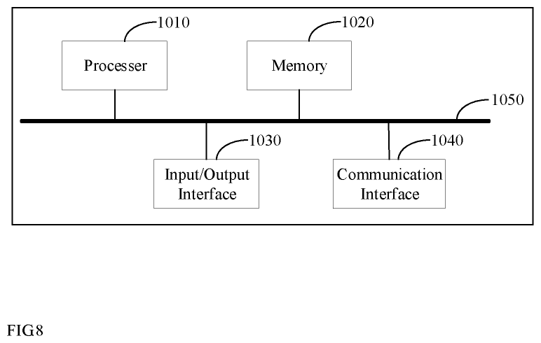

Optionally, as shown in FIG. 7, the apparatus further includes: a first halt module 701, configured to, in a case that the game is in the second state, in response to determining that the second operation information is abnormal based on a preset operation rule, switch the game to a halt state.

Optionally, as shown in FIG. 7, the apparatus further includes: a second halt module 702, configured to, in a case that the game is in the second state or the result processing state, in response to detecting that the first marker in the preset area is changed, switch the game to a halt state.

Optionally, the first state switching module 601, configured to, in a case that the game is in the halt state, switch the game to the first state according to the first state switching instruction; or, the second state switching module 603, configured to, in a case that the game is in the halt state, switch the game to the second state according to second state switching instruction; or, the result state switching module 605, configured to, in a case that the game is in the halt state, switch the game to the result processing state according to result state switching instruction.

Optionally, the preset area includes a first operating area for the first object to perform an operation, the first operation information detecting module 602, further configured to, in a case that the game is in the first state, acquire, based on a video stream of the preset area, the first operation information of one or more operations performed on the first marker by the first object in the first operating area.

Optionally, the first operating area includes two or more first operating sub-areas, the first operation information detecting module 602, further configured to acquire the first operation information of one or more operations performed on the first marker by the first object in each of the first operating sub-areas.

Optionally, the preset area includes a second operating area for the second object to perform an operation, the second operation information detecting module 604, further configured to, in a case that the game is in the second state, acquire, based on a video stream of the preset area, the second operation information of one or more operations performed on the second marker by the second object in the second operating area.

Optionally, the second operating area includes two or more second operating sub-areas, the second operation information detecting module 604, further configured to acquire the second operation information of one or more operations performed on the second marker by the second object in each of the second operating sub-areas.

Optionally, the result state switching module 605, further configured to, in a case that the game is in the second state, detect, based on a video stream of the preset area, second identification information of the second marker in the second operating area; determine the game result based on the second identification information.

Optionally, as shown in FIG. 7, the apparatus further includes: a first video stream detecting module 703, configured to, in response to switching the game to the first state, acquire the first operation information from a detection based on an acquired video stream of the preset area; and/or, a second video stream detecting module 704, configured to, in response to switching the game to the second state, acquire the second operation information from a detection based on the acquired video stream of the preset area; the video stream includes respective video streams which are synchronously captured in the preset area from a plurality of viewing angles, the plurality of viewing angles includes at least one side viewing angle and at least one top viewing angle, the at least one side viewing angle includes a left side viewing angle and/or a right side viewing angle.

Optionally, the first operation information detecting module 602, further configured to, in response to switching the game to the first state, acquire the first operation information by performing a detection on a plurality of images included in a video stream of the preset area; the first operation information detecting module 602, configured to perform a detection on any one of the images included in the video stream includes: performing a detection on the image to determine current first identification information of the first marker in the image; determining the first operation information according to a difference between the current first identification information and historical first identification information stored for the game.

Optionally, the second operation information detecting module 604, configured to, in response to switching the game to the second state, acquire the second operation information by performing a detection on a plurality of images included in a video stream of the preset area; the second operation information detecting module 604, configured to perform a detection on any one of the images included in the video stream by performing a detection on the image to determine current second identification information of the second marker in the image; and, determining the second operation information according to a difference between the current second identification information and historical second identification information stored for the game.

Optionally, the first marker indicates one or more game coins; the second marker indicates one or more cards; the current second identification information or the historical second identification information includes one or more of the following: card value, suit, information of located area, location information.

As for the apparatus embodiment, since it substantially corresponds to the method embodiment, relevant parts can be referred to the description of the method embodiment. The apparatus embodiments described above are only schematic, in which the units described as separate components may or may not be physically separated, and the components displayed as units may or may not be physical units, that is, they may be located in one place or distributed to multiple network units. Some or all of the modules can be selected according to actual needs to achieve the purpose of at least one embodiment of the present disclosure. Those of ordinary skill in the art can understand and implement it without creative labor.

The disclosure further provides a computer device, which includes a memory, a processor and a computer program stored on the memory and executable on the processor, when the computer program is executed by a processor, the method of processing game states according to any of the embodiments of the disclosure can be implemented.

FIG. 8 shows a more specific hardware structure diagram of a computer device provided by an embodiment of the present disclosure, and the device may include a processor 1010, a memory 1020, an input/output interface 1030, a communication interface 1040, and a bus 1050. The processor 1010, the memory 1020, the input/output interface 1030, and the communication interface 1040 implement a communication connection between each other inside the device through the bus 1050.

The processor 1010 may be implemented by using a common central processing unit (CPU), a microprocessor, an Application specific integrated circuit (ASIC), or one or more integrated circuits, etc., for executing relevant programs to implement the technical solutions provided by the embodiments of the present description.

The memory 1020 may be implemented in the form of a read only memory (ROM), a random access memory (RAM), a static storage device, a dynamic storage device, and the like. The memory 1020 may store an operating system and other application programs. When the technical solutions provided in the embodiments of the present specification are implemented through software or firmware, related program codes are stored in the memory 1020 and are invoked and executed by the processor 1010.

The input/output interface 1030 is used to connect an input/output module to realize information input and output. The input/output/module can be configured in the device as a component (not shown in the figure), or it can be connected to the device to provide corresponding functions. The input device may include a keyboard, a mouse, a touch screen, a microphone, various sensors, etc., and an output device may include a display, a speaker, a vibrator, an indicator light, and the like.

The communication interface 1040 is used to connect a communication module (not shown in the figure) to implement communication interaction between the device and other devices. The communication module can realize communication through wired means (such as USB, network cable, etc.), or through wireless means (such as mobile network, WIFI, Bluetooth, etc.).

The bus 1050 includes a path to transmit information between various components of the device (for example, the processor 1010, the memory 1020, the input/output interface 1030, and the communication interface 1040).

It should be noted that although the above device only shows the processor 1010, the memory 1020, the input/output interface 1030, the communication interface 1040, and the bus 1050, in the specific implementation process, the device may also include other necessary components for normal operation. In addition, those skilled in the art can understand that the above-mentioned device may also include only the components necessary to implement the solutions of the embodiments of the present specification, and not necessarily include all the components shown in the figures.

The present disclosure further provides a computer readable storage medium having a computer program stored thereon, when the program is executed by a processor, the method of processing game states according to any of the embodiments of the disclosure can be implemented.

The non-transitory computer readable storage medium may be ROM, random access memory (RAM), CD-ROM, magnetic tape, floppy disk, optical data storage device, etc., which is not limited in the present disclosure.

In some optional embodiments, a computer program product is provided by the embodiment of the present disclosure, which includes computer readable code, when the computer-readable code is running on a device, the processor in the device executes a method of processing game states provided by any one of the embodiments. The computer program product can be implemented specific by hardware, software or a combination thereof.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that programmable not disclosure in the present disclosure. The specification and examples are considered as exemplary only, with a true scope and spirit of the present disclosure being indicated by the following claims.

It should be understood that the present disclosure is not limited to the precise structure described above and shown in the accompanying drawings, and that various modifications and changes can be made without departing from the scope thereof. The scope of the present disclosure is limited only by the appended claims.

The above are only preferred examples of the present disclosure, and are not used to limit the present disclosure. Any modification, equivalent replacement, improvement within the spirit and principle of the present disclosure shall be included in the protection scope of the present disclosure.

1. A method of processing game states, comprising:
in response to a first state switching instruction, switching a game from an idle state to a first state;
acquiring first operation information of one or more operations performed on a first marker by a first object participating in the game in the first state;
in response to detecting a second marker in a preset area, switching the game to a second state;
acquiring second operation information of one or more operations performed on the second marker by a second object participating in the game in the second state;
in response to that a game result is generated based on the second operation information, switching the game to a result processing state;
performing result processing on the first operation information according to the game result.

2. The method according to claim 1, further comprises:
in a case that the game is in the second state, in response to determining that the second operation information is abnormal based on a preset operation rule, switching the game to a halt state.

3. The method according to claim 1, further comprises:
in a case that the game is in the second state or the result processing state, in response to detecting that the first marker in the preset area is changed, switching the game to a halt state.

4. The method according to claim 2, further comprises:
in a case that the game is in the halt state,
switching the game to the first state according to the first state switching instruction; or,
switching the game to the second state according to second state switching instruction; or,
switching the game to the result processing state according to result state switching instruction.

5. The method according to claim 1, wherein, the preset area comprises a first operating area for the first object to perform an operation, acquiring the first operation information of one or more operations performed on the first marker by the first object participating in the game in the first state comprises:
in a case that the game is in the first state, acquiring, based on a video stream of the preset area, the first operation information of one or more operations performed on the first marker by the first object in the first operating area.

6. The method according to claim 5, wherein the first operating area comprises two or more first operating sub-areas, acquiring the first operation information of one or more operations performed on the first marker by the first object in the first operating area comprises:
acquiring the first operation information of one or more operations performed on the first marker by the first object in each of the first operating sub-areas.

7. The method according to claim 1, wherein the preset area comprises a second operating area for the second object to perform an operation, acquiring the second operation information of one or more operations performed on the second marker by the second object participating in the game in the second state comprises:
in a case that the game is in the second state, acquiring, based on a video stream of the preset area, the second operation information of one or more operations performed on the second marker by the second object in the second operating area.

8. The method according to claim 7, wherein the second operating area comprises two or more second operating sub-areas, acquiring the second operation information of one or more operations performed on the second marker by the second object in the second operating area comprises:
acquiring the second operation information of one or more operations performed on the second marker by the second object in each of the second operating sub-areas.

9. The method according to claim 7, wherein, generating the game result based on the second operation information comprises:
in a case that the game is in the second state, detecting, based on a video stream of the preset area, second identification information of the second marker in the second operating area;
determining the game result based on the second identification information.

10. The method according to claim 1, further comprises at least one of:
in response to switching the game to the first state, acquiring the first operation information from a detection based on an acquired video stream of the preset area; or,
in response to switching the game to the second state, acquiring the second operation information from a detection based on the acquired video stream of the preset area;
wherein, the video stream comprises respective video streams which are synchronously captured in the preset area from a plurality of viewing angles, the plurality of viewing angles comprises at least one side viewing angle and at least one top viewing angle, the at least one side viewing angle comprises at least one of a left side viewing angle or a right side viewing angle.

11. The method according to claim 1, acquiring the first operation information of one or more operations performed on the first marker by the first object participating in the game in the first state, comprises:
in response to switching the game to the first state, acquiring the first operation information by performing a detection on a plurality of images comprised in a video stream of the preset area;
wherein, performing a detection on any one of the images comprised in the video stream comprises:
performing a detection on the image to determine current first identification information of the first marker in the image;
determining the first operation information according to a difference between the current first identification information and historical first identification information stored for the game.

12. The method according to claim 1, acquiring the second operation information of one or more operations performed on the second marker by the second object participating in the game in the second state, comprises:
in response to switching the game to the second state, acquiring the second operation information by performing a detection on a plurality of images comprised in a video stream of the preset area;
wherein, performing a detection on any one of the images comprised in the video stream comprises:
performing a detection on the image to determine current second identification information of the second marker in the image;
determining the second operation information according to a difference between the current second identification information and historical second identification information stored for the game.

13. The method according to claim 12, wherein
the first marker indicates one or more game coins;
the second marker indicates one or more cards;
the current second identification information or the historical second identification information comprises one or more of the following: card value, suit, information of located area, location information.

14. A computer device, comprising:
at least one processor; and
one or more memories coupled to the at least one processor and storing programming instructions for execution by the at least one processor to perform operations for processing game states, the operations comprising:
in response to a first state switching instruction, switching a game from an idle state to a first state;
acquiring first operation information of one or more operations performed on a first marker by a first object participating in the game in the first state;
in response to detecting a second marker in a preset area, switching the game to a second state;
acquiring second operation information of one or more operations performed on the second marker by a second object participating in the game in the second state;
in response to that a game result is generated based on the second operation information, switching the game to a result processing state;
performing result processing on the first operation information according to the game result.

15. The computer device according to claim 14, wherein the operations further comprise:
in a case that the game is in the second state, in response to determining that the second operation information is abnormal based on a preset operation rule, switching the game to a halt state.

16. The computer device according to claim 14, wherein the operations further comprise:
in a case that the game is in the second state or the result processing state, in response to detecting that the first marker in the preset area is changed, switching the game to a halt state.

17. The computer device according to claim 15, wherein the operations further comprise:
in a case that the game is in the halt state,
switching the game to the first state according to the first state switching instruction; or,
switching the game to the second state according to second state switching instruction; or,
switching the game to the result processing state according to result state switching instruction.

18. The computer device according to claim 14, wherein, the preset area comprises a first operating area for the first object to perform an operation, acquiring the first operation information of one or more operations performed on the first marker by the first object participating in the game in the first state comprises:
in a case that the game is in the first state, acquiring, based on a video stream of the preset area, the first operation information of one or more operations performed on the first marker by the first object in the first operating area.

19. The computer device according to claim 18, wherein the first operating area comprises two or more first operating sub-areas, acquiring the first operation information of one or more operations performed on the first marker by the first object in the first operating area comprises:
acquiring the first operation information of one or more operations performed on the first marker by the first object in each of the first operating sub-areas.

20. A computer readable storage medium coupled to the at least one processor and storing programming instructions for execution by the at least one processor, wherein the programming instructions instruct the at least one processor to perform operations for processing game states, the operations comprising:
in response to a first state switching instruction, switching a game from an idle state to a first state;
acquiring first operation information of one or more operations performed on a first marker by a first object participating in the game in the first state;
in response to detecting a second marker in a preset area, switching the game to a second state;
acquiring second operation information of one or more operations performed on the second marker by a second object participating in the game in the second state;
in response to that a game result is generated based on the second operation information, switching the game to a result processing state;
performing result processing on the first operation information according to the game result.
